(19) United States
(12) Patent Application Publication
(10) Pub. No.: US 2015/0298145 A1
(43) Pub. Date: Oct. 22, 2015

(54) VARIABLE FLOW NOZZLE

(71) Applicant: Lindsay Corporation, Omaha, NE (US)

(72) Inventor: Aaron Paul Sauser, Tilden, MO (US)

(73) Assignee: Lindsay Corporation, Omaha, NE (US)

(21) Appl. No.: 14/256,373

(22) Filed: Apr. 18, 2014

(51) Int. Cl. B05B 1/32; A01G 25/09

(52) U.S. Cl. CPC B05B 1/32; A01G 25/09

(57) ABSTRACT

A fluid delivery system for use in an irrigation system comprises a pressure regulator, a variable flow nozzle, and a sprinkler. The pressure regulator reduces the fluid pressure of the fluid to a normalized pressure. The variable flow nozzle includes a housing and first and second rollers. The housing defines an inlet, an interior chamber, and an outlet. The rollers are positioned side by side in the interior chamber of the housing and each define a recessed channel extending circumferentially around longitudinal axes of the rollers and gradually increasing in size. The channels cooperatively form an orifice between the rollers for fluid to pass therethrough. The variable flow nozzle increases or decreases the fluid flow rate of the fluid by rotating the rollers so that the orifice increases or decreases in size.

### BACKGROUND

Embodiments of the present invention relate to fluid delivery systems. More particularly, embodiments of the present invention relate to an improved variable flow nozzle for use in a fluid delivery system of an agricultural irrigation system.

Irrigation systems such as center-pivot and linear systems are commonly used to irrigate agricultural fields and often include several movable support towers and a fluid conduit extending between the movable support towers for distributing water, herbicides, pesticides, or other fluid to crops in the fields. The fluid is pumped from a fluid supply through the fluid conduit to a number of spray points between the movable support towers. Because the fluid is typically pumped at a high pressure, the pressure must be regulated before the fluid is sprayed onto the crops. This may be done with fluid delivery systems mounted to the fluid conduit at the spray points. A typical fluid delivery system includes a pressure regulator, a variable flow nozzle, and a sprinkler. The pressure regulator is attached to the fluid conduit, the variable flow nozzle is attached to an outlet of the pressure regulator, and the sprinkler is attached to an outlet of the variable flow nozzle. The pressure regulator reduces the fluid pressure to a low and steady pressure suitable for spraying the fluid on the crops. The variable flow nozzle adjusts the fluid flow rate of the depressurized fluid to increase or decrease the amount of fluid sprayed on the crops. The sprinkler disperses the fluid in all directions so that the fluid is evenly distributed onto the crops.

The variable flow nozzles of these systems alter the fluid flow rate of the fluid by shifting or rotating slotted, cam-shaped, or plug components relative to a fluid channel to direct the fluid through a portion of the slot or past the cam or plug. The flow path through the slot or past the cam or plug includes sharp turns and/or instantaneous increases or decreases in effective diameter. This can result in cavitation and water hammer, which may damage the variable flow nozzle and makes automatic control of the variable flow nozzle difficult. Fluid forces acting on the slotted, cam-shaped, and plug components also complicate automatic control of the variable flow nozzle.

### SUMMARY

The present invention solves the above-described problems and provides a distinct advance in the art of fluid delivery systems for irrigation systems. More particularly, the present invention provides a fluid delivery system that regulates a fluid flow rate of the fluid without causing cavitation, water hammer, and other undesirable effects.

A fluid delivery system constructed in accordance with an embodiment of the present invention broadly comprises a pressure regulator, a variable flow nozzle, and a sprinkler or other fluid delivery mechanism.

The pressure regulator is attached to a fluid conduit of an irrigation system and reduces the fluid pressure to a lower pressure suitable for spraying onto crops.

The variable flow nozzle is attached to an outlet of the pressure regulator and adjusts the fluid flow rate of the fluid after the fluid pressure is reduced by the pressure regulator. An embodiment of the variable flow nozzle includes a housing, a first roller, a second roller, and a motor. The housing includes a fluid inlet, a fluid outlet, and a drive shaft opening. The housing also includes gaskets or seals for preventing fluid from escaping through its openings.

The first and the second rollers each include an axial shaft, a set of gear teeth, and an outer circumferential surface. The axial shaft extends from the ends of the roller and is aligned with axial bosses in the housing. One of the axial shafts extends through the drive shaft opening of the housing and is drivably connected to the motor. The gear teeth are positioned circumferentially around a longitudinal axis of the roller at one or both ends of the roller. The outer circumferential surface is cylindrical and has a recessed channel. The channel extends circumferentially around the longitudinal axis of the roller and gradually increases in size.

The first and the second rollers are positioned side by side in the housing such that their longitudinal axes extend parallel to each other and such that a line of contact between the rollers extends substantially perpendicular to an axis extending from the fluid inlet to the fluid outlet. The gear teeth of the first roller rotationally engage the gear teeth of the second roller and the outer circumferential surfaces of the first and second rollers contact each other along the line of contact. The channels of the first and second rollers cooperatively form an orifice between the first and second rollers, thus forming a direct fluid path between the fluid inlet and the fluid outlet of the housing.

The motor is coupled with the axial shaft of one of the first and second rollers and is operable to actuate the variable flow nozzle by rotating one of the rollers about its longitudinal axis. The rotationally engaged gear teeth of the driven roller transfer rotational force to the other roller such that the rollers rotate together in opposite directions. The outer circumferential surfaces maintain a rolling contact with each other, preventing fluid from flowing therebetween. The channels rotate around the longitudinal axes such that the orifice becomes larger or smaller depending on the rotational position and/or the direction of the rollers. For example, the orifice becomes larger when it is formed in a variable flow region of the channels and when the rollers are rotating in a first direction. The orifice becomes smaller when it is formed in the variable flow region and when the rollers are rotating in a second direction opposite the first direction. The orifice is largest when the rollers are rotated to a maximum flow position such that the orifice is formed in a maximum flow region. The orifice is closed when the rollers are rotated to a closed position. The fluid flow is increased or decreased according to the change in size of the orifice.

The sprinkler or other fluid delivery mechanism receives the fluid from the variable flow nozzle and disperses the fluid to reach a larger swath of crops and to prevent fluid from pooling directly under the fluid delivery system.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of an exemplary irrigation system on which fluid delivery systems constructed in accordance with embodiments of the invention may be mounted;

FIG. 2 is an elevational view of one of the fluid delivery systems of FIG. 1;

FIG. 3 is a perspective view of a variable flow nozzle of the fluid delivery system of FIG. 2;

FIG. 4 is an exploded view of the variable flow nozzle of FIG. 3;

FIG. 5 is another exploded view of the variable flow nozzle of FIG. 3;

FIG. 6 is a perspective view of the variable flow nozzle of FIG. 3;

FIG. 7 is another perspective view of the variable flow nozzle of FIG. 3;

FIG. 8a is sectional view of the variable flow nozzle of FIG. 3;

FIG. 8b is another sectional view of the variable flow nozzle of FIG. 3;

FIG. 8c is another sectional view of the variable flow nozzle of FIG. 3; and

FIG. 8d is another sectional view of the variable flow nozzle of FIG. 3.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

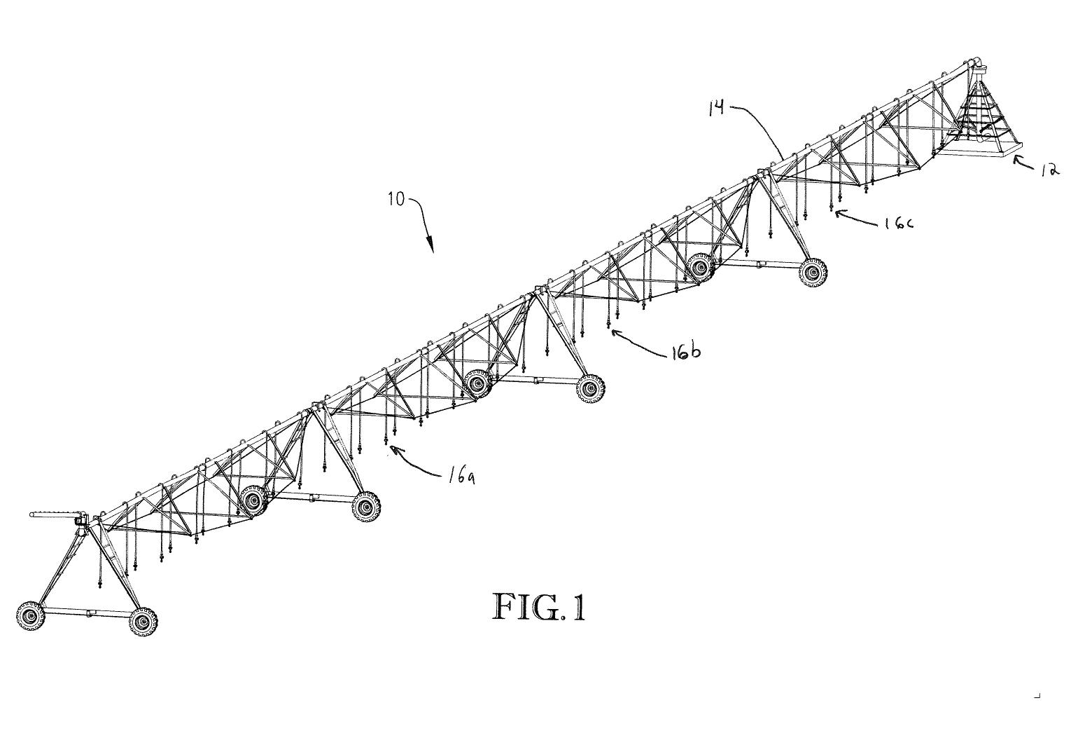

Turning now to the drawing figures, and initially FIG. 1, an exemplary irrigation system 10 on which the fluid delivery systems of the present invention may be mounted is illustrated. The illustrated agricultural irrigation system 10 is a center-pivot irrigation system that broadly comprises a stationary fluid source 12, a number of movable support towers, a number of spans, and a fluid conduit 14. The movable support towers support the spans, elevate the fluid conduit 14, and move the spans and the fluid conduit 14 across a field or other area to be irrigated. The spans extend between the movable support towers and support the fluid conduit 14 between the movable support towers. The fluid conduit 14 is connected to the stationary fluid source 12 and extends outwardly from the stationary fluid source 12 along the spans. The fluid conduit 14 transports fluid from the stationary fluid source 12 to a number of fluid delivery systems 16a-c for irrigating the field or other area with water, herbicide, pesticide, or other fluids. It will be understood that embodiments of the invention may be used with other irrigation systems such as sprayers and linear and stationary irrigation systems.

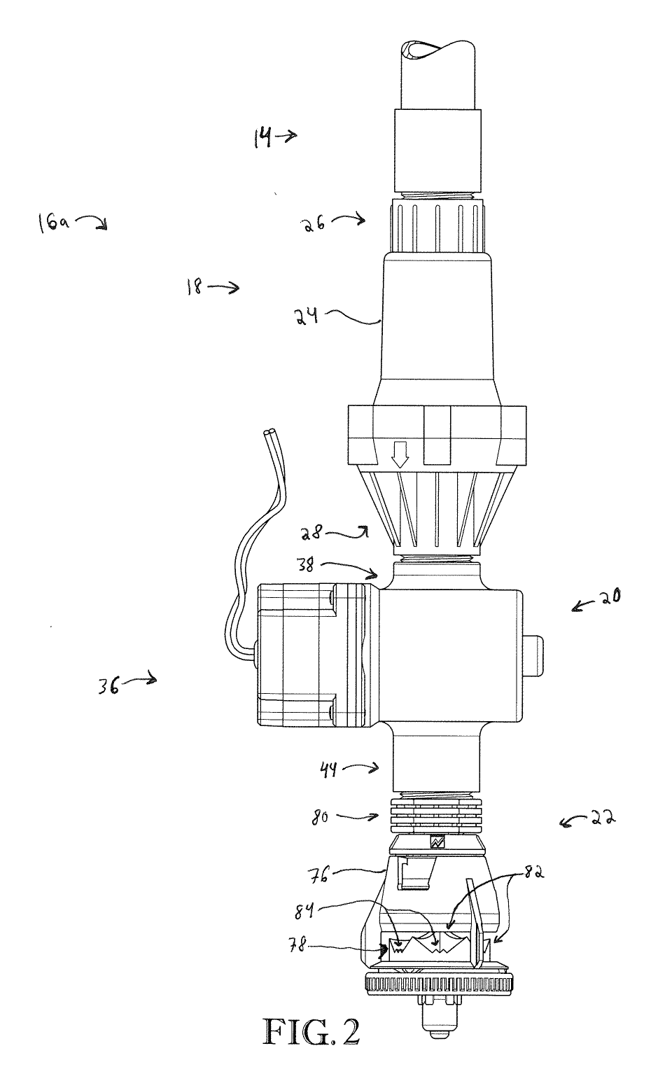

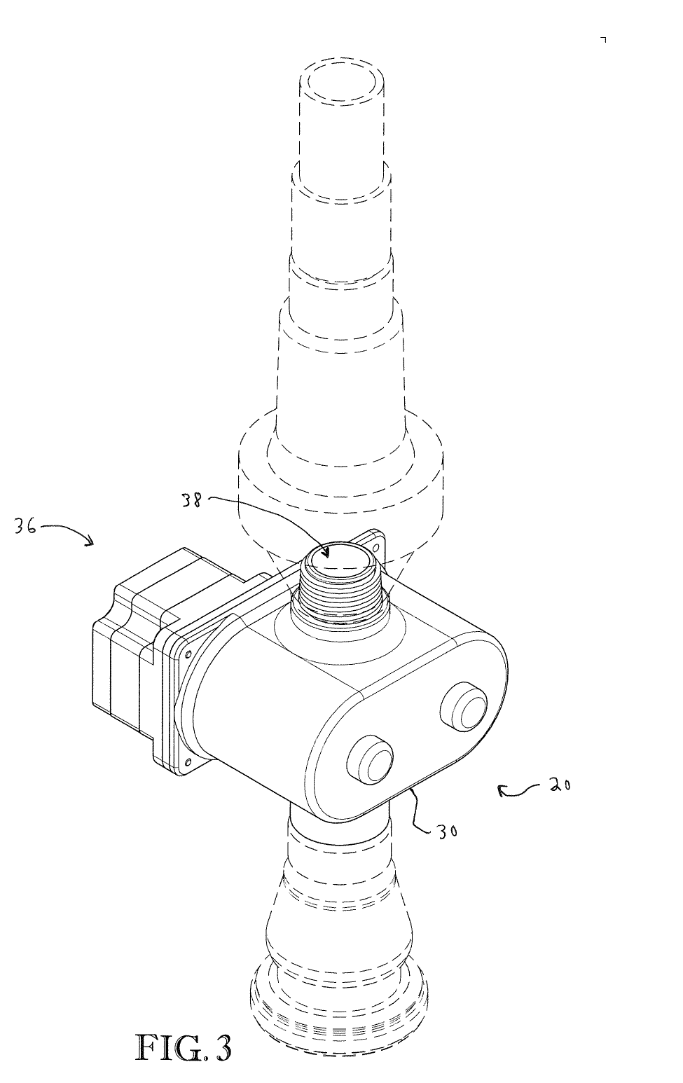

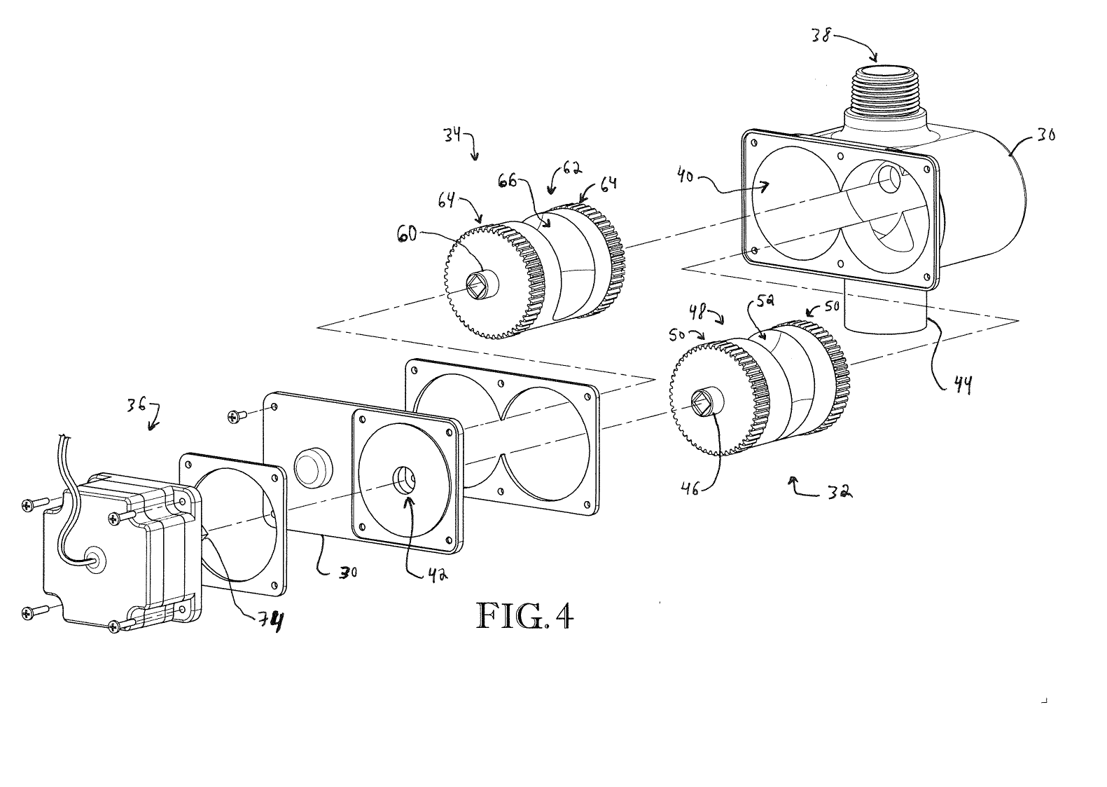

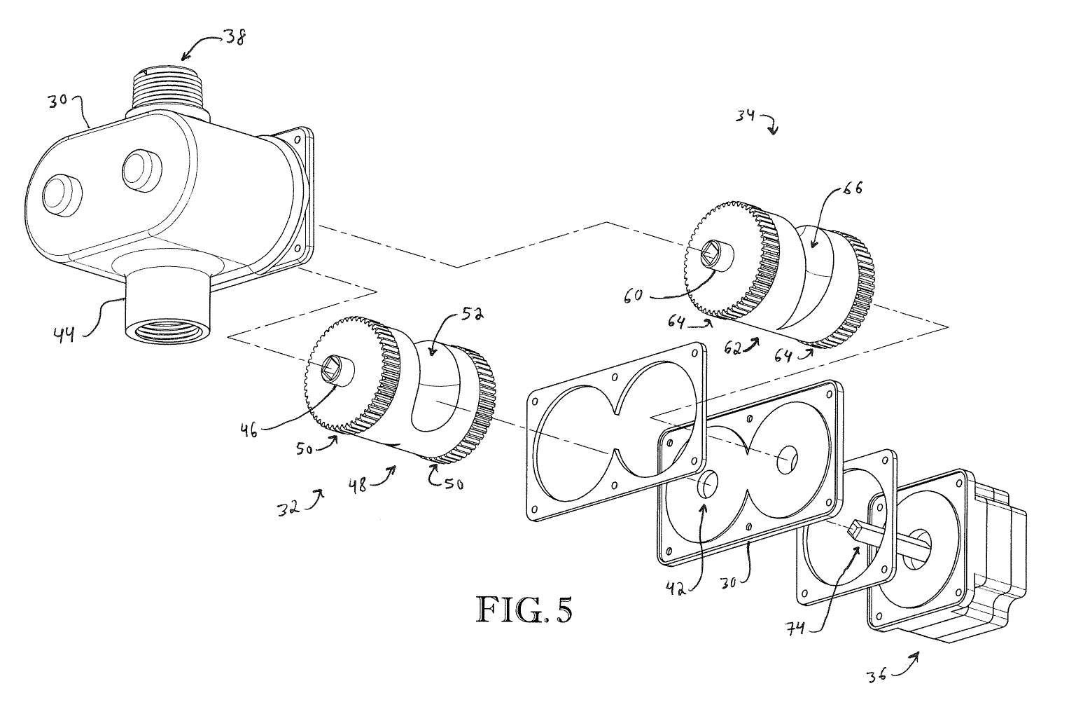

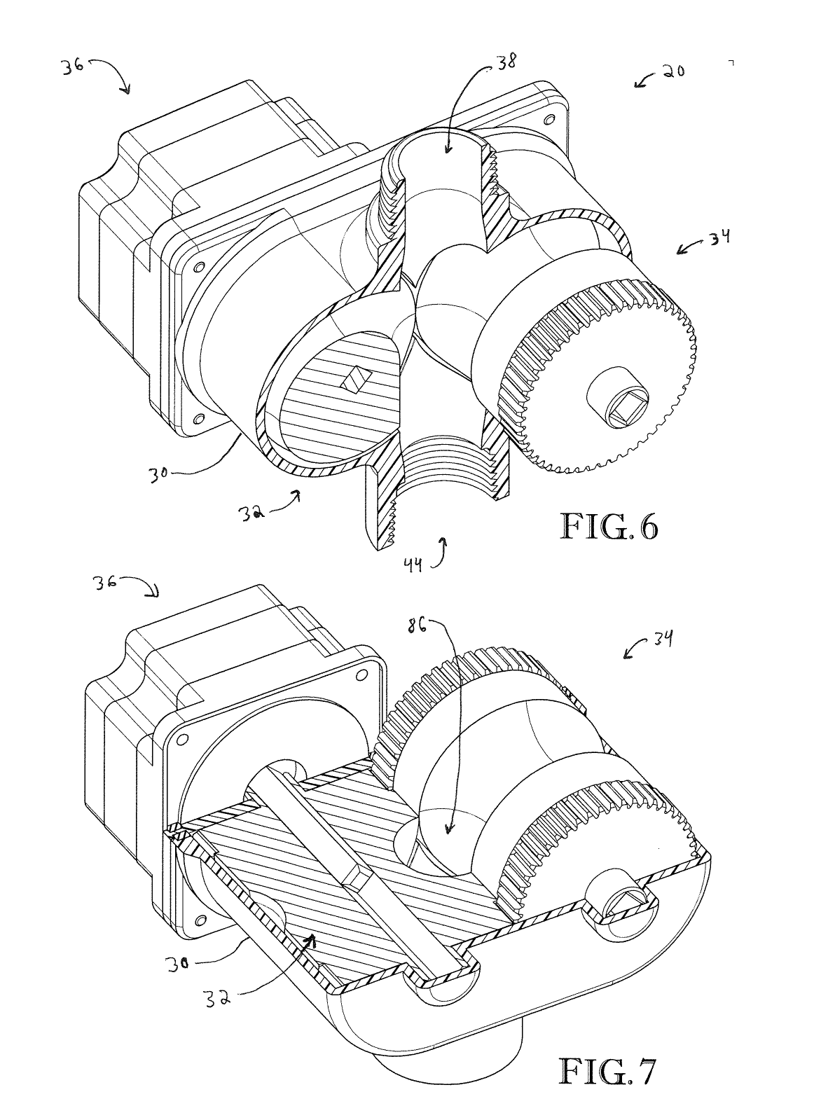

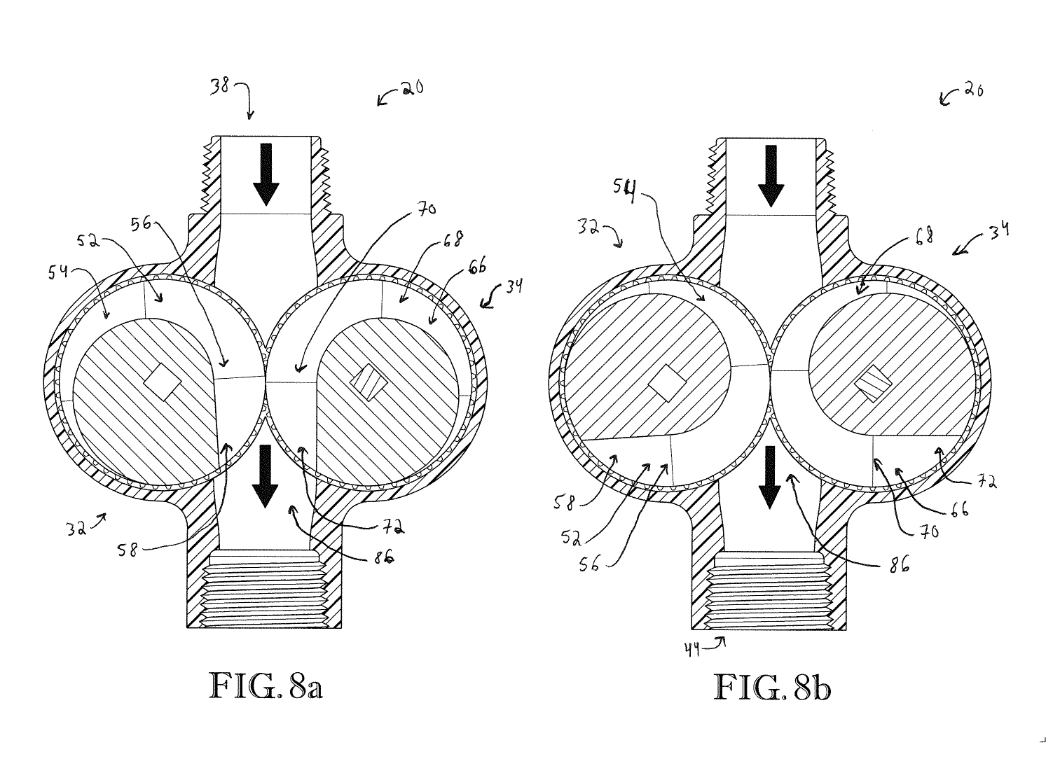

Because the fluid delivery systems 16a-c are essentially identical, only one of them, fluid delivery system 16a, will be described in detail. As best shown in FIGS. 2-8d, the fluid delivery system 16a broadly includes a pressure regulator 18, a variable flow nozzle 20, and a sprinkler 22 or other fluid delivery mechanism.

The pressure regulator 18 reduces and normalizes the high fluid pressure in the fluid conduit 14 to a lower stable fluid pressure suitable for spraying onto crops as described below. An embodiment of the pressure regulator 18 comprises a housing 24 and an internal valve, as shown in FIG. 2.

The housing 24 may be formed of plastic, aluminum, cast iron, or other suitable material and includes an inlet 26, an internal channel, and an outlet 28. The inlet 26 connects the pressure regulator 18 to the fluid conduit 14 for receiving the high pressure fluid from the fluid conduit 14 and may be a male or female threaded or friction fitted connector located at a first end of the internal channel. The internal channel extends from the inlet 24 to the outlet 26 and directs the fluid through the internal valve. The outlet 26 connects the pressure regulator 18 to an inlet of the variable flow nozzle 20 for delivering the regulated fluid to the variable flow nozzle 20 and may be a male or female threaded or friction fitted connector located at a second end of the internal channel opposite the first end.

The internal valve reduces and normalizes the pressure of the fluid and includes a restrictor, a diaphragm, and a spring or other biasing member. The restrictor partially obstructs the internal channel and is connected to the diaphragm. The restrictor may be a poppet, ball, or butterfly restrictor. The diaphragm is connected to the restrictor and is positioned in the internal channel downstream of the restrictor. The spring provides a stabilizing counterforce to the diaphragm and the restrictor and is connected to the diaphragm.

The variable flow nozzle 20 is positioned downstream from the pressure regulator 18 and upstream from the sprinkler 22 and adjusts the fluid flow rate after the fluid pressure is reduced in the pressure regulator 18 as described below. An embodiment of the variable flow nozzle 20 includes a housing 30, a first roller 32, a second roller 34, and a motor 36.

The housing 30 encloses the first and second rollers 32, 34 and may be formed of plastic, aluminum, cast iron, or any other suitable material. The housing 30 includes an inlet 38, an interior chamber 40, a drive shaft opening 42, and an outlet 44. The housing 30 also includes partitions, gaskets, and/or seals for preventing fluid from escaping through the drive shaft opening 42 and for directing fluid between the first and second rollers 32, 34.

The inlet 38 connects to the outlet 28 of the pressure regulator 18 for receiving the regulated fluid from the pressure regulator 18 and may be a male or female threaded or friction fitted connector located at a first end of the interior chamber 40.

The interior chamber 40 extends from the inlet 38 to the outlet 44 and directs the fluid from the inlet 38, between the first and second rollers 32, 34 and to the outlet 44.

The drive shaft opening 42 receives an axial shaft of the first roller 32 therethrough and includes a gasket and/or seal for retaining fluid in the interior chamber 40.

The outlet 44 connects to an inlet of the sprinkler 22 for delivering fluid from the variable flow nozzle 20 to the sprinkler 22 and may be a male or female threaded or friction fitted connector located at a second end of the interior chamber 40 opposite the first end.

The rollers 32, 34 cooperatively regulate the fluid flow in the variable flow nozzle and in one embodiment are substantially cylindrical. The rollers 32, 34 may be formed of machined aluminum, cast iron, or any other suitable material. The first roller 32 is positioned adjacent to the second roller 34 in the interior chamber 40 between the inlet 38 and the outlet 44 and defines a longitudinal axis extending substantially perpendicular to and offset from a path from the inlet 38 to the outlet 44. The first roller 32 includes an axial shaft 46, an outer circumferential surface 48, and a set of gear teeth 50.

The axial shaft 46 maintains an axial alignment of the first roller 32 with respect to the housing 30 and receives a driving torque from the motor 36. The axial shaft 46 extends from either end of the first roller 32 and through the drive shaft opening 42 in the housing 30 for connecting to a drive component of the motor 36.

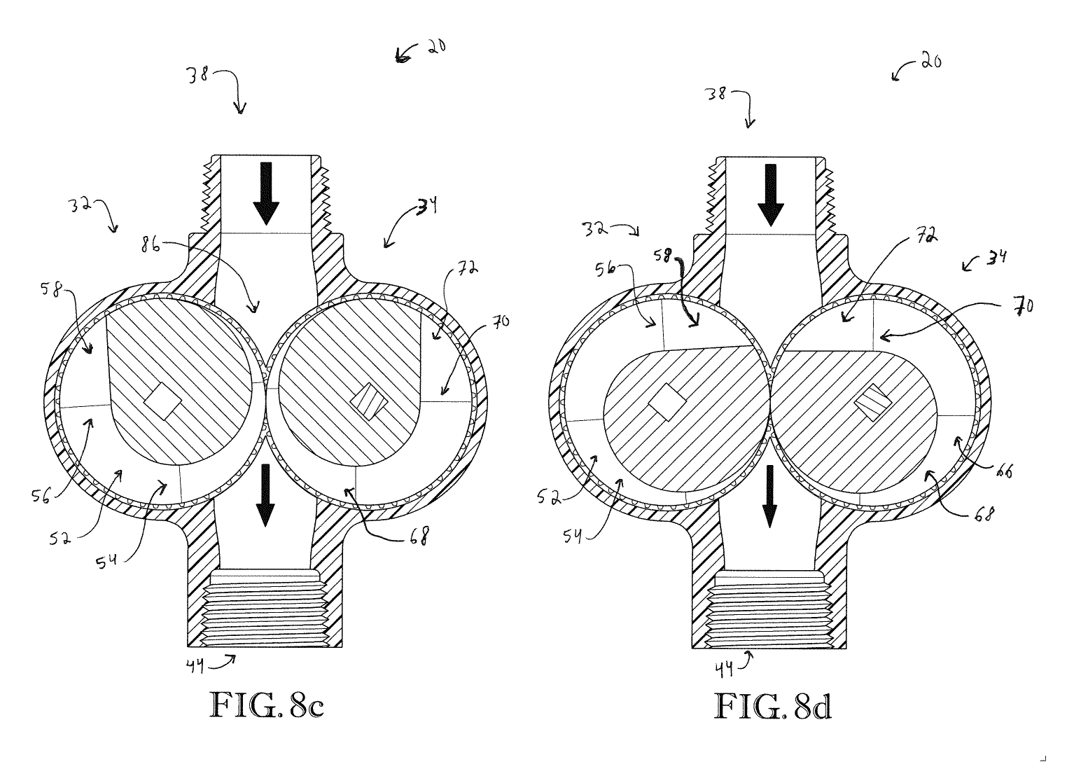

The outer circumferential surface 48 is substantially cylindrical and has a recessed channel 52 spaced between the ends of the first roller 32. The channel 52 may be semi-circular or any other shape and extends circumferentially around the longitudinal axis of the first roller 32. The channel 52 defines a variable flow region 54, a maximum flow region 56 at the end of the variable flow region 54, and an extension region 58 near the maximum flow region 56 opposite the variable flow region 54, as shown in FIGS. 8a-d. The channel 52 gradually increases in size in the variable flow region 54 to its largest size in the maximum flow region 56 and decreases in size beyond the maximum flow region 56 in the extension region 58. The channel 52 may deepen and/or widen to achieve its gradually increasing and decreasing size.

The gear teeth 50 maintain a rolling contact between the outer circumferential surface 48 of the first roller 32 and the outer circumferential surface of the second roller 34 and may be straight or helix gear teeth. The gear teeth 50 are positioned circumferentially around the longitudinal axis of the first roller 32 at one or both ends of the first roller 32 and rotationally engage the gear teeth of the second roller 34 for transferring rotational energy thereto.

The second roller 34 is positioned adjacent to the first roller 32 in the interior chamber 40 between the inlet 38 and the outlet 44 and defines a longitudinal axis extending substantially parallel to the longitudinal axis of the first roller 32 and offset from a path from the inlet 38 to the outlet 44. The second roller 34 includes an axial shaft 60, an outer circumferential surface 62, and a set of gear teeth 64.

The axial shaft 60 maintains an axial alignment of the second roller 34 with respect to the housing 30. The axial shaft 60 extends from either end of the second roller 34 and is rotationally seated in a boss or other feature in the housing 30.

The outer circumferential surface 62 is substantially cylindrical and has a recessed channel 66 spaced between the ends of the second roller 34. The channel 66 may be semi-circular or any other shape and extends circumferentially around the longitudinal axis of the second roller 34. The channel 66 defines a variable flow region 68, a maximum flow region 70 at the end of the variable flow region 68, and an extension region 72 near the maximum flow region 70 opposite the variable flow region 68, as shown in FIGS. 8a-d. The channel 66 gradually increases in size in the variable flow region 68 to its largest size in its maximum flow region 70 and decreases in size beyond the maximum flow region 70 in the extension region 72. The channel 66 may deepen and/or widen to achieve its gradually increasing and decreasing size.

The gear teeth 64 maintain a rolling contact between the outer circumferential surface 62 of the second roller 34 and the outer circumferential surface 48 of the first roller 32 and may be straight or helix gear teeth. The gear teeth 64 are positioned circumferentially around the longitudinal axis of the second roller 34 at one or both ends of the second roller 34 and rotationally engage the gear teeth of the first roller 32 for receiving rotational energy therefrom.

The motor 36 drives the first roller 32 and may be a servo, a solenoid, or any other electric motor or other device for providing rotational energy. The motor is positioned outside the housing 30 and includes electrical circuitry and a drive shaft 74, a belt, a gear, and/or other drive components. The electrical circuitry communicates wirelessly with an irrigation controller and controls the motor 36. The drive shaft 74 and other drive components rotationally engage the axial shaft 46 of the first roller 32.

The sprinkler 22 or other fluid delivery mechanism disperses the fluid in a large area around the fluid delivery system 16a as described below and includes a housing 76 and a sprinkler plate 78, as shown in FIG. 2. The housing 76 is formed of plastic, aluminum, cast iron, or any other suitable material and includes an inlet 80 and a set of radial openings 82. The inlet 80 connects to the outlet 44 of the variable flow nozzle 20 and may be a male or female threaded or friction fitted connector. The radial openings 82 allow fluid to exit the sprinkler 22 laterally and are separated by structural dividers. The sprinkler plate 78 redirects the fluid out of the radial openings and is positioned centrally in the housing and substantially perpendicular to a longitudinal axis of the inlet 80. The sprinkler plate 78 includes a number of radially extending chutes 84 for spreading the fluid and may be rotatable about the longitudinal axis of the inlet 80.

Fluid flow through the irrigation system 10 and the fluid delivery system 16a will now be described in more detail. The irrigation system 10 delivers high pressure fluid from the stationary fluid source 12 to the inlet of the pressure regulator 18 via the fluid conduit 14 as the irrigation system 10 traverses the field.

The high pressure fluid enters the inlet 26 of the pressure regulator 18 from the fluid conduit 14 of the irrigation system 10. The high pressure fluid flows past the restrictor and exerts a force on the diaphragm that pulls the restrictor towards a closed position, which tends to reduce the fluid pressure beyond the restrictor. The spring generates a counter force on the diaphragm and pushes the restrictor towards an open position, which tends to increase the fluid pressure beyond the restrictor. The two forces equalize and keep the restrictor at an intermediate position so that the fluid pressure of the fluid entering the variable flow nozzle 20 downstream from the restrictor is normalized at a lower, predetermined magnitude. The lower pressure fluid then flows through the outlet 28 of the pressure regulator 18 to the inlet 38 of the variable flow nozzle 20.

The fluid then flows through the inlet 38 of the variable flow nozzle 20 into the interior chamber 40 of the variable flow nozzle 20. The fluid continues through an orifice 86 cooperatively formed by the channels 52, 66 of the first and second rollers 32, 34. The outer circumferential surface 48 of the first roller 32 and the outer circumferential surface 62 of the second roller 34 maintain continuous contact with each other between the rollers 32, 34 except for at the orifice 86 so that fluid flows only through the orifice 86 and not between the outer circumferential surfaces 48, 62. The fluid then flows through the outlet 44 of the variable flow nozzle 20 to the inlet 80 of the sprinkler 22. The channels 52, 66 cooperatively form the orifice 86 substantially directly between the inlet 38 and the outlet 44 of the variable flow nozzle 20 such that the fluid flows through the inlet 38, the orifice 86, and the outlet 44 substantially in a straight line.

Fluid flowing from the outlet 44 of the variable flow nozzle 20 enters the inlet 80 of the sprinkler 22 or other fluid delivery mechanism. The fluid hits the sprinkler plate 78 and the radially extending chutes 84 divert the fluid laterally from the sprinkler 22. The force of the fluid hitting the radially extending chutes 84 rotates the sprinkler plate 78 so that the fluid is evenly dispersed around the fluid delivery system 16a.

The fluid flow rate in the variable flow nozzle 20 may be adjusted for increasing or decreasing the amount of fluid being delivered by the fluid delivery system 16a as follows: first, the irrigation controller of the irrigation system 10 determines that the amount of fluid being delivered by the fluid delivery system 16a should be increased or decreased and wirelessly transmits a signal representing an instruction to increase or decrease the fluid flow rate. The electric circuitry of the motor 36 then activates the motor 36, which actuates the first roller 32 via the drive shaft and drive components of the motor 36 and the axial shaft of the first roller 32. The gear teeth 50 of the first roller 32 transfer rotational energy to the gear teeth 64 of the second roller 34 such that the first and second rollers 32, 34 rotate in opposite directions with respect to each other about their axial shafts 46, 60. The outer circumferential surface 48 of the first roller 32 and the outer circumferential surface 62 of the second roller 34 maintain a rolling contact with each other when the first and second rollers 32, 34 rotate so that fluid only flows through the orifice 86. The orifice 86 increases in size, thereby increasing the fluid flow rate, when the first and second rollers 32, 34 rotate in a first direction and the orifice 86 is formed in the variable flow regions 54, 68 of the channels 52, 66, as shown in FIG. 8a. The orifice 86 reaches its maximum size, thereby maximizing the fluid flow rate, when the first and second rollers 32, 34 are rotated to a maximum flow position so that the orifice 86 is formed in the maximum flow regions 56, 70 of the channels 52, 66, as shown in FIG. 8b. The orifice 86 extends along the direction of fluid flow from the maximum flow regions 56, 70 through the extended portions 58, 72 of the channels 52, 66 such that the extended portions 58, 72 extend substantially parallel to each other when the first and second rollers 32, 34 are in the maximum flow position. The orifice 86 decreases in size, thereby decreasing the fluid flow rate, when the first and second rollers 32, 34 rotate in a second direction and the orifice 86 is formed in the variable flow regions 54, 68 of the channels 52, 66, as shown in FIG. 8c. The orifice 86 is reduced to a size of zero area, thereby reducing the flow rate to zero, when the first and second rollers 32, 34 are rotated to a closed position such that the outer circumferential surfaces 48, 62 are in continuous contact with each other from first ends to opposite ends of the rollers 32, 34, as shown in FIG. 8d.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A variable flow nozzle comprising:
a housing comprising:
outer walls defining an interior chamber;
an inlet; and
an outlet;
a first roller positioned in the interior chamber of the housing and having a first outer circumferential surface including a recessed channel extending circumferentially around a first longitudinal axis and increasing in cross sectional area, the first roller being configured to rotate around the first longitudinal axis; and
a second roller positioned in the interior chamber of the housing and having a second outer circumferential surface including a recessed channel extending circumferentially around a second longitudinal axis and increasing in cross sectional area, the second roller being configured to rotate around a second longitudinal axis substantially parallel to the first longitudinal axis,
the first outer circumferential surface and the second outer circumferential surface being positioned to contact each other such that portions of the channels cooperatively form an orifice so that fluid flows through the orifice and does not flow between the first and second outer circumferential surfaces, the first roller and the second roller being configured to maintain a rolling contact with each other such that different portions of the channels cooperatively form the orifice when the rollers rotate so that the orifice changes in size for increasing or decreasing the flow rate of the fluid flowing through the orifice.

2. The variable flow nozzle of claim 1, wherein the first roller and the second roller each include at least one set of gear teeth configured to rotationally engage each other for maintaining a rolling contact between the first and second outer circumferential surfaces.

3. The variable flow nozzle of claim 2, wherein the at least one set of gear teeth includes a first set of gear teeth on a first end of the roller and a second set of gear teeth on a second end of the roller opposite the first end.

4. The variable flow nozzle of claim 1, wherein one of the rollers is configured to transfer rotational energy to the other roller.

5. The variable flow nozzle of claim 1, further comprising a motor drivably connected to one of the rollers through the housing and configured to rotate the rollers.

6. The variable flow nozzle of claim 1, further comprising a servo drivably connected to one of the rollers through the housing and configured to rotate the rollers.

7. The variable flow nozzle of claim 1, wherein the channels of the first and the second surfaces extend less than 360 degrees around the first longitudinal axis and the second longitudinal axis respectively such that the first surface and the second surfaces are cooperatively configured to prevent fluid from flowing between the first and the second rollers when the first and the second rollers are rotated to a closed position.

8. The variable flow nozzle of claim 1, wherein the channels of the first and the second surfaces are symmetrical about a plane extending between the first and the second rollers.

9. The variable flow nozzle of claim 1, wherein the orifice is substantially circular regardless of the rotational position of the rollers.

10. The variable flow nozzle of claim 1, wherein the channels of the first and second surfaces each have a maximum depth of approximately one half of the radius of one of the rollers.

11. The variable flow nozzle of claim 1, wherein the first and the second rollers are configured to increase the size of the orifice when rotated in a first direction and to decrease the size of the orifice when rotated in a second direction.

12. The variable flow nozzle of claim 1, wherein the channels of the first and the second surfaces extend at least 270 degrees around the first longitudinal axis.

13. The variable flow nozzle of claim 1, wherein the channels of the first and the second surfaces cooperatively define a variable flow region and a maximum flow region, the first and the second rollers being cooperatively configured to increase the flow of fluid through the orifice when rotating in a first direction and when the orifice is formed in the variable flow region, to decrease the flow of fluid through the orifice when rotating in a second direction opposite the first direction and when the orifice is formed in the variable flow region, and to maximize the flow of fluid through the orifice when rotated to a maximum flow position such that the orifice is formed in the maximum flow region.

14. The variable flow nozzle of claim 13, wherein a portion of the channel of the first surface and a portion of the channel of the second surface are configured to extend parallel to each other from the maximum flow region when the first and the second rollers are rotated to the maximum flow position so as to form an extended orifice of uniform diameter.

15. A fluid delivery system comprising:
a pressure regulator comprising:
a housing comprising:
outer walls defining an interior channel;
an inlet located at an end of the interior channel for receiving fluid from a fluid source; and
an outlet located at an end of the interior channel opposite the inlet; and
a valve configured to maintain a downstream pressure of the fluid flowing through the interior channel to the outlet;
a variable flow nozzle downstream from the pressure regulator, the variable flow nozzle comprising:
a housing comprising:
outer walls defining an interior chamber;
an inlet connected to an outlet of the pressure regulator; and
an outlet;
a first roller positioned in the interior chamber of the housing and having a first outer circumferential surface including a recessed channel extending circumferentially around a first longitudinal axis and increasing in cross sectional area, the first roller being configured to rotate around the first longitudinal axis; and
a second roller positioned in the interior chamber of the housing adjacent the first roller and having a second outer circumferential surface including a recessed channel extending circumferentially around a second longitudinal axis substantially parallel to the first longitudinal axis and increasing in cross sectional area, the second roller being configured to rotate around the second longitudinal axis,
the first outer circumferential surface and the second outer circumferential surface being configured to contact each other such that portions of the channels cooperatively form an orifice so that fluid flows through the orifice and does not flow between the first and second outer circumferential surfaces, and the first roller and the second roller being configured to maintain a rolling contact with each other such that different portions of the channels cooperatively form the orifice when the rollers rotate so that the orifice changes in size for increasing or decreasing the flow rate of the fluid flowing through the orifice; and
a sprinkler downstream of the variable flow nozzle, the sprinkler comprising:
an inlet connected to the outlet of the variable flow nozzle for receiving the fluid flowing from the orifice; and
a sprinkler plate for dispersing the fluid onto an area to be irrigated.

16. The fluid delivery system of claim 15, wherein the variable flow nozzle is configured to direct the fluid to a center of the sprinkler plate.

17. The fluid delivery system of claim 15, further comprising a motor drivably connected to one of the rollers through a drive shaft opening of the housing of the variable flow nozzle, the motor being configured to rotate the rollers for changing the size of the orifice.

18. The fluid delivery system of claim 15, wherein the channel of the first surface and the channel of the second surface extend circumferentially less than 360 degrees around the first longitudinal axis and the second longitudinal axis respectively such that the first surface and the second surface are cooperatively configured to completely prevent fluid from flowing between the first and the second rollers when the first and the second rollers are rotated to a closed position.

19. The fluid delivery system of claim 15, wherein the orifice is substantially circular regardless of the rotational position of the rollers.

20. A variable flow nozzle comprising:
a housing comprising:
outer walls defining an interior chamber;
an inlet; and
an outlet;
a first roller positioned in the interior chamber and having a first and a second set of gear teeth and a first outer circumferential surface including a recessed channel extending circumferentially around a first longitudinal axis and increasing in cross sectional area, the first roller being configured to rotate around the first longitudinal axis; and
a second roller positioned in the interior chamber adjacent to the first roller and having a third and fourth set of gear teeth and a second outer circumferential surface including a recessed channel extending circumferentially around a second longitudinal axis substantially parallel to the first longitudinal axis and increasing in cross sectional area, the second roller being configured to rotate around the second longitudinal axis,
the first outer circumferential surface and the second outer circumferential surface being configured to contact each other such that portions of the channels cooperatively form an orifice so that fluid flows through the orifice and does not flow between the first and second outer circumferential surfaces, the first roller and the second roller being configured to rotate around the longitudinal axes such that different portions of the channels cooperatively form the orifice so that the orifice changes in size for increasing or decreasing the flow rate of the fluid flowing through the orifice, and the first and the second sets of gear teeth being configured to rotationally engage the third and fourth sets of gear teeth for maintaining a rolling contact between the first roller and the second roller.
